(19) United States
(12) Patent Application Publication
(10) Pub. No.: US 2018/0349017 A1
(43) Pub. Date: Dec. 6, 2018

(54) SYSTEM, METHOD FOR DISPLAYING HANDWRITING SYNCHRONOUSLY, AND HANDWRITING DEVICE

(71) Applicants: WEN-BIN CHEN, Taipei City (TW); BANDRICH, INC., Taipei City (TW)

(72) Inventors: WEN-BIN CHEN, Taipei City (TW); HAN-PO TSAI, Taipei City (TW)

(21) Appl. No.: 15/712,915

(22) Filed: Sep. 22, 2017

(30) Foreign Application Priority Data
Jun. 2, 2017 (TW) 106118278

(51) Int. Cl. G06F 3/0488; H04N 5/04; G06T 11/20

(52) U.S. Cl. CPC G06F 3/04883; G06T 2200/28; G06T 11/20; H04N 5/04

(57) ABSTRACT

The present disclosure is related to a system and a system for displaying handwriting synchronously, and a handwriting device thereto. The handwriting device adopts a bistable display panel and includes a sensor circuitry that is used to record the handwriting contents over the panel. The sensor circuitry through the handwriting renders handwriting positions and pressure values. These sensed data is transmitted to a computer device instantly when the data of positions and pressure values are generated by the handwriting device. In the computer device, the handwriting can be synchronously displayed through a transformation from the received data to displaying positions and pressure values. Finally, in the computer device, a document recording the handwriting track over time is created. The document can be a picture, a video, or even a document with audio.

### BACKGROUND OF THE INVENTION

### 1. Field of the Invention

The present disclosure relates generally to a system and a method for displaying a handwriting track and, more particularly, to a handwriting device with a bistable display panel, a system including a computer device receiving handwriting data via a connection and a method for synchronously displaying the handwriting track.

### 2. Description of Related Art

A handwriting board is generally applicable to text input or drawing. One of the conventional handwriting boards utilizes an electromagnetic-induction panel that allows a user to conduct handwriting operation by using a stylus over the panel. A sensing circuitry inside the electromagnetic-induction panel is able to sense changes of electric field between the panel and the stylus. A series of changes of the electric field can be used to compute a handwriting track that may render a text input or drawing.

Another type of the handwriting board utilizes a capacitance sensing panel or a resistance sensing panel. The sensing panel senses a touch signal when a user uses his fingertip or a handwriting tool to contact the sensing panel. A series of touch signals are used to infer the handwriting track.

In general, conventional handwriting boards are used for input or to replace the function of a computer mouse. However, a text, a drawing or a command is still rendered by a computer that is connected with the handwriting board.

### SUMMARY OF THE INVENTION

The present disclosure is generally related to a system for synchronously displaying a handwriting track, a method for the same, and a handwriting device. In addition to the conventional applications such as inputting text, drawing or command, the system can be applicable to show a handwriting track that is synchronized with another computer device. In the synchronous process, the system can record the tracks that form a document. The document can be shared by using a specific software program or used for further applications.

In one aspect of the invention, the system for synchronously displaying a handwriting track essentially includes a handwriting device and a non-transitory storage medium in a computer. A series of instructions that carry out the method for synchronously displaying a handwriting track are stored in the storage medium. The main elements of the handwriting device include a control unit, a bistable display panel electrically connected to the control unit, a sensing unit and a communication unit. The bistable display panel is used to display a picture that is generated by handwriting; the sensing unit is used to sense handwriting data over the bistable display panel; and the communication unit is used to synchronously transmit the handwriting data to a computer device.

The instructions stored in the non-transitory storage medium are executed by one or more processors for receiving handwriting data from the handwriting device. The handwriting data includes a handwriting position, coverage thereof, and a pressure value with respect to the handwriting position. The handwriting data is then converted into displaying data that renders the handwriting track which is synchronously displayed on a display screen of the computer device. A document can be formed by the handwriting track over time.

In one further aspect of the invention, in the step of synchronously displaying the handwriting track, an audio is also synchronously recorded so as to produce a document of the handwriting track over time.

According to one of the embodiments of the method, the method is adapted to a system including a handwriting device and a computer sequence executed in a computer device and the handwriting device. In the method, the computer sequence executed in the computer device can periodically receive handwriting data from the handwriting device. The handwriting data is then converted into the displaying data displayed on the display screen. The displaying data renders the handwriting track shown on the display screen. A document can be formed by the handwriting track over time.

### BRIEF DESCRIPTION OF THE DRAWINGS

FIG. 1A and FIG. 1B show a schematic diagram depicting a system for synchronously displaying a handwriting track according to one of the embodiments of the present disclosure;

FIG. 2 shows a diagram depicting function blocks of the system in one embodiment of the present disclosure;

FIG. 3 shows a flow chart describing a process to form handwriting data in a method for displaying the handwriting track in one embodiment of the present disclosure;

FIG. 4 shows a flow chart describing the method for synchronously displaying the handwriting track in one embodiment of the present disclosure;

FIG. 5 shows another flow chart describing the method for synchronously displaying the handwriting track in one embodiment of the present disclosure; and

FIG. 6 shows a flow chart describing the method in another embodiment of the present disclosure.

### DETAILED DESCRIPTION OF THE PREFERRED EMBODIMENTS

The present invention will now be described more fully with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present disclosure is generally related to a system for synchronously displaying a handwriting track, and a method thereof. The system includes a handwriting device that exemplarily adopts a bistable display panel. The handwriting device connects a computer device over a wired or a wireless communication. The computer device can synchronously display the track rendered by the handwriting device so as to form a document that records the handwriting data. The document can be a graphic file or a video file created in the computer device. The document can also be applicable to various applications. For example, the document is such as a handwriting image or a video that can be shared in chat software or on social websites. It is noted that the handwriting track rendered or played in the computer device over time is not easy to be shared according to the conventional technology.

In particular, the bistable display panel adapted by the handwriting device can be implemented by one of a Microcapsules Electrophoretic, a Gyricon Bead, and a Cholesteric Liquid Crystal. In an exemplary example, the Cholesteric Liquid Crystal Display (CLCD) is a display containing a liquid crystal with a helical structure and which is therefore chiral. The Cholesteric liquid crystals are also known as chiral nematic liquid crystals. The states of the molecules of the Cholesteric liquid crystals vary with an amount of voltage pulse and time so as to reflect two rotation states of polarized light such as reflection and transmission states. Therefore the Cholesteric liquid crystal panel can show the images of black and white. Further, the Cholesteric Liquid Crystal forms a bistable display panel that is classified as a reflection display utilizing ambient light to show the images without using a backlight.

Furthermore, an advantage of the bistable display panel is that only when the displaying data shown thereon changes, electricity is required. That is, power supply for the panel can be turned off for saving power while the displaying data remains on the bistable display panel.

The sensing unit of the bistable display panel is such as a resistance-type touch-sensitive panel or electromagnetic-induction type touch-sensitive panel. The resistance-type touch-sensitive panel or the electromagnetic-induction type touch-sensitive panel senses an external pressure applied to the bistable elements of the bistable display panel when a user touches the bistable display panel using his fingertip, a stylus or other objects. The bistable elements are such as a bistable thin film. The electrodes of the bistable thin film will be deformed when an external pressure is applied thereto, and the external pressure causes the bistable elements to generate resistance impedance. A driving circuit of the system will sense a change of the resistance impedance that allows the system to determine the handwriting position. It is worth noting that the sensing unit can be a resistance-type touch-sensitive panel or an electromagnetic-induction type touch-sensitive panel.

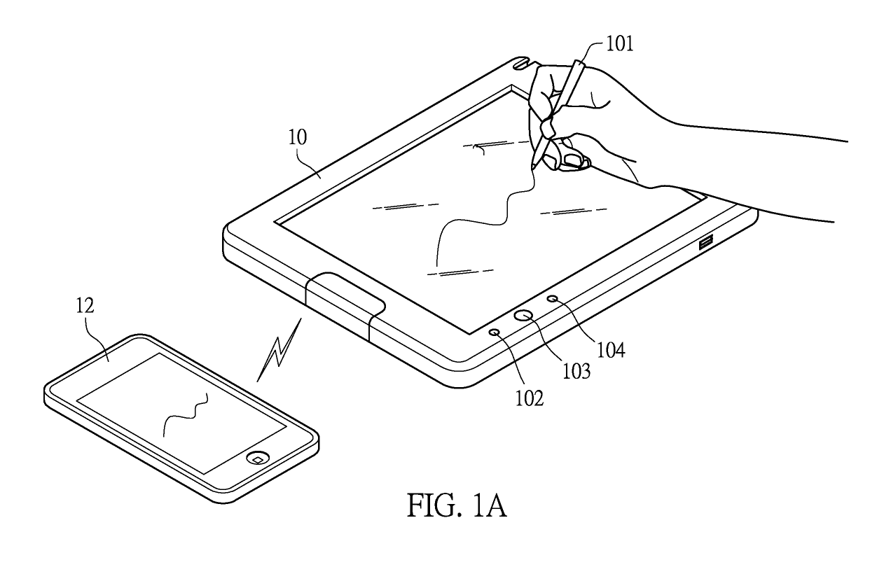

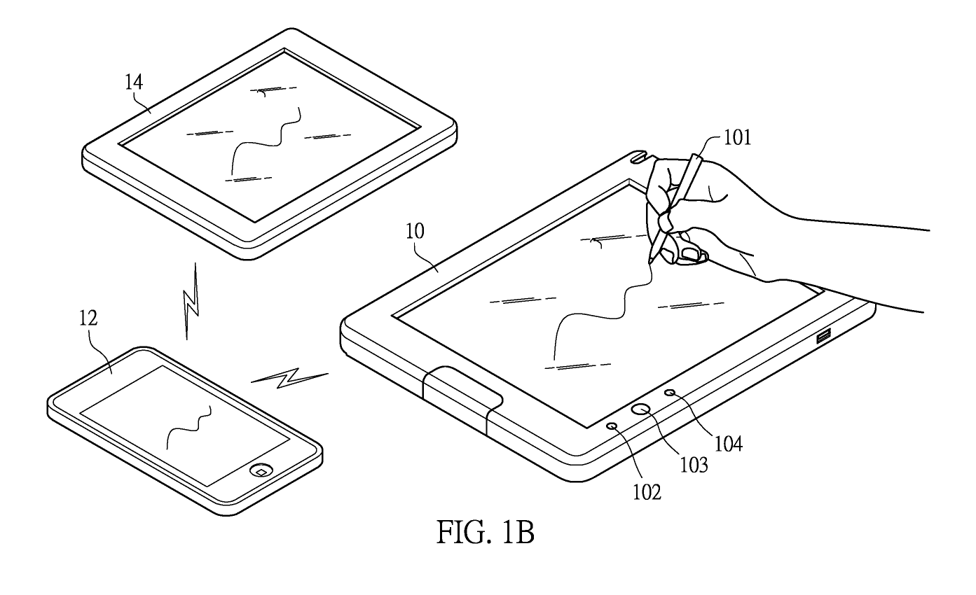

The system of the present disclosure can be referred to the description of one embodiment in FIG. 1A.

A handwriting device 10 exemplarily adopts a bistable display panel that allows the user to form a handwriting track over the handwriting device 10 using his fingertip or a specific handwriting tool 101, e.g. a stylus. A display screen is provided to display the handwriting track. The handwriting device 10 is connected with a computer device 12 over a wired or a wireless communication. The wired communication can be implemented by USB. The wireless communication is exemplarily made by a Bluetooth™ communication technology. An initialization process of the Bluetooth™ communication technology requires a pairing process to establish the connection between the handwriting device 10 and the computer device 12. The wireless communication may also be implemented by other communication technologies such as WiFi™ or NFC.

In the method for synchronously displaying the handwriting track, a computer sequence executed in the computer device 12 receives the handwriting data from the handwriting device 10. The handwriting data can be periodically transferred for embodying the synchronous displaying. During the synchronous transmission, the system can synchronously record the handwriting track for producing a video or an animation. One or more function buttons 102, 103 and 104 disposed on the handwriting device 10 can be used to perform additional functions such as clearing the screen, performing a specified application and storing the handwriting data.

For example, when the user uses a handwriting tool 101 to do writing on a plane of the handwriting device 10, the handwriting data rendered by the handwriting device 10 is synchronously transmitted to the computer device 12, and in the meantime the handwriting device 10 displays the handwriting track. After finishing contents of a page, pressing a clear function button can clear the screen. A control circuit of the bistable display panel enables a signal to execute the function of clearing the display screen. The user can continue to do writing on the display screen while the handwriting data is continuously transferred to the computer device 12. The process of synchronous transmission or recording may not be interrupted due to the process of clearing the screen unless the user manipulates the computer device 12 or the handwriting device 10 to carry out an interruption.

The function button for performing a specified application of the handwriting device 10 is to enable a signal to make the computer device 12 to initiate a corresponding computer sequence. For example, the function button may make the computer device 10 to initiate a social application that allows the user to share the document of handwriting data rendered by the handwriting device 10 with others.

After the user finishes his handwriting task, the handwriting data such as a drawing or a video can be automatically stored by virtue of the storing function button of the handwriting device 10. When the storing function button is enabled, the handwriting data can be temporarily stored in a memory of the handwriting device 10. Alternatively, the handwriting data can be transmitted to the computer device 12 and forms a document to be stored in the memory of the computer device 12 when the storing function button is pressed.

FIG. 1B shows another embodiment of the system for synchronously displaying the handwriting track. The system also supports connecting with multiple handwriting devices such as the handwriting device 10 and a second handwriting device 14 as shown in the figure. The system allows the computer device 12 to connect with the handwriting device 10 and the second handwriting device 14 at the same time. The computer device 12 can simultaneously communicate with the multiple handwriting devices, or by time sharing scheme. Both the handwriting devices 10 and 14 adopt the bistable display panels.

The computer device 12 in one mode can pair with multiple handwriting devices 10 and 14. The computer sequence assists the computer device 12 in switching the connection to the handwriting device 10 or to the handwriting device 14. In a specific requirement, the user can use his fingertip or a specific handwriting tool 101 to form a handwriting track on the handwriting devices 10 and 14, and the handwriting devices 10 and 14 respectively generate their own handwriting data with individual identification data. In the computer sequence for performing synchronous handwriting, the computer device 12 is able to switch one of the connections to the handwriting devices according to a source of the received handwriting data. The identification data allows the system to identify the source of the handwriting data. Therefore the system integrates the handwriting tracks generated from both the handwriting device 10 and the second handwriting device 14, and displays the integrated handwriting tracks.

By this scheme, the system can continuously receive the handwriting tracks from the handwriting devices 10 and 14 for synchronously displaying the tracks, including synchronous recording. The computer sequence operated in the computer device 12 can also process the instructions initiated by the function buttons 102, 103, 104 of the handwriting devices 10 and 14 at the same time.

In one aspect, the handwriting data respectively generated by the handwriting devices 10 and 14 can be separately stored. In another aspect, the handwriting data respectively generated by the handwriting devices 10 and 14 can be integrated. For example the handwriting tracks can be superimposed in one document.

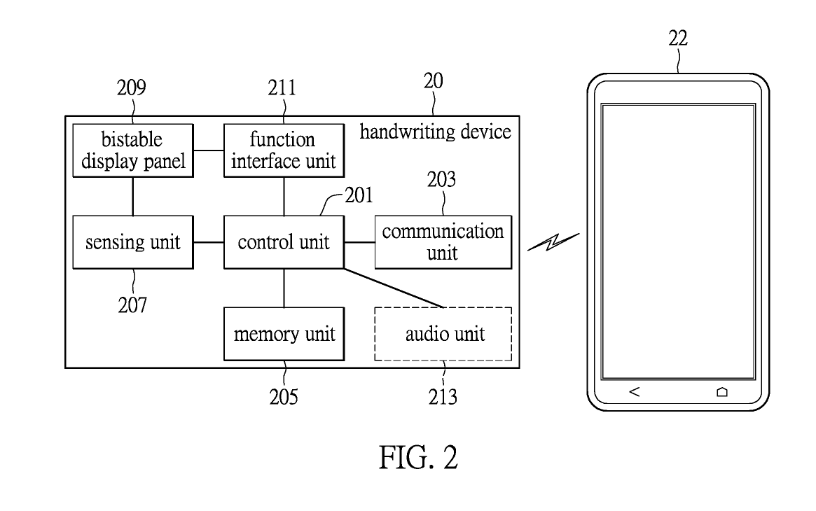

Reference is next made to FIG. 2 showing circuit blocks depicting the system for synchronously displaying the handwriting track.

A handwriting device 20 communicates with a computer device 22 via a specific communication protocol. The computer device 22 can be a mobile device or a personal computer that installs an application program for synchronously displaying the handwriting track. The handwriting device 20 and the application program executed in the computer device 22 constitute the system of the present disclosure.

The main circuits of the handwriting device 20 include a control unit 201 and some electronic components electrically connected with the control unit 201. One of the electronic components is such as a circuit for managing power supply (not shown in this figure). The control unit 201 is used to control operations of the handwriting device 20. The control unit 201 controls a communication unit 203 to process the signals communicating with the computer device 22. The communication signals are converted into the data in compliance with a specific communication protocol. The control unit 201 controls the sensing unit 207 to generate the handwriting data and transforms the handwriting positions (the coordinates) and pressure values into the data that is transmitted to the computer device 22.

The subsystems of the handwriting device 20 include a bistable display panel 209 and a sensing unit 207 coupled to the bistable display panel 209. The bistable display panel 209 is characterized in that when displaying the handwriting image, minimal electric power is required. Consequently, continuously supplying power to the display to display the image is unnecessary as when the image changes, only minimal electric power is required to change the display state.

The sensing unit 207 coupled to the bistable display panel 209 can be a kind of touch-sensitive panel that is used to sense the touch signals for forming the handwriting data over the bistable display panel 209. The touch-sensitive panel such as the resistance-type touch-sensitive panel or the electromagnetic-induction type touch-sensitive panel generates the touch signals when the panel senses the touch event formed by using a handwriting tool or the like. The pixels corresponding to the touch signals render a series of handwriting positions. The control unit 201 then outputs the corresponding coordinate data. Further, every touch event formed by using the fingertip or the handwriting tool may cover a certain range of the pixels around the handwriting position. The handwriting data synchronously transmitted to the computer system 22 includes coordinate data and the pixels of coverage with respect to the handwriting position.

In another embodiment, the sensing unit 207 includes the touch-sensitive panel and a pressure transducer. The pressure transducer allows the touch-sensitive panel to output a pressure value that presents the force applied to a touch point. The force softly or heavily applied to the touch-sensitive panel will produce different pressure values by the pressure transducer. The system accordingly provides different functions or applications based on the varied pressure values. In the method, the pressure transducer is used to sense the handwriting pressures which are served as a part of the handwriting data. In addition, no matter the handwriting track is displayed on the bistable display panel 209 of the handwriting device 20 or on the computer device 22, a depth or a thickness thereof is shown in response to the pressure value.

The handwriting device 20 includes a communication unit 203 that is used to transmit the handwriting data under a specific communication protocol. The communication unit 203 is embodied by a wired or a wireless communication for the transmission. When the handwriting data is generated by the bistable display panel 209, the panel 209 shows the handwriting track and the communication unit 203 synchronously transmits the handwriting data to the computer device 22.

In one aspect, the handwriting device 20 converts the signals generated by the sensing unit 207 into the data in compliance with the specific communication protocol, and actively initiates the transmission connection with the computer device 22. In one further aspect, the computer device 22 can periodically poll data from the handwriting device 20 for achieving synchronous transmission and displaying.

The handwriting device 20 includes a function interface unit 211 that is electrically connected with the control unit 201. The function interface unit 211 primarily provides one or more functions through one or more function buttons of the handwriting device 20. The function buttons generate signals when they are pressed by the user.

In yet another embodiment, the handwriting device 20 includes a built-in memory unit 205. The memory unit 205 is used to temporarily buffer the received handwriting data for providing the synchronous data. The memory unit 205 is also used to store the handwriting data including the handwriting positions, the coverage, and the pressure values. The handwriting device 20 can be a standalone device without being connected to the computer device 22 since its memory temporarily retains the handwriting data. The handwriting data is then transmitted to the computer device 22 when the handwriting device 20 is connected with the computer device 22.

The system can synchronously record audio when the user conducts the handwriting operation using the handwriting device 20. The audio and the handwriting track are synchronously stored so as to form a document. In one aspect, the handwriting device 20 includes an audio unit 213 that is used to record the sound using an external microphone when the handwriting is in process. The system allows the user to write while recording the audio. Therefore, the handwriting track can be accompanied with the synchronous sound. The computer device 22 can also be in charge of recording the audio using a recording device while the handwriting is in process. A video document can be produced.

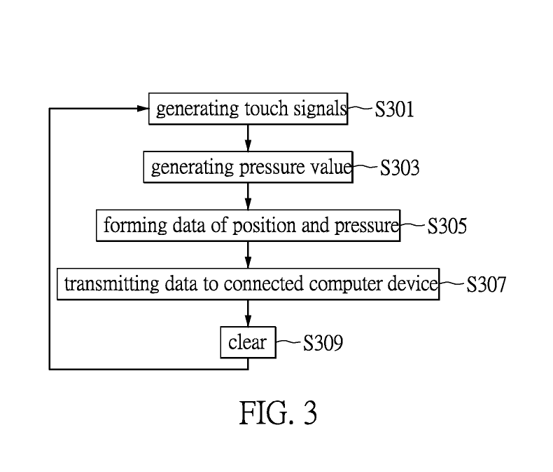

The system allows the user to write on the bistable display panel directly so as to form his personalized handwriting. The handwriting shows the user's handwriting pressure that can be described by a value of thickness and depth. FIG. 3 shows a flow chart describing the method for forming the handwriting data according to one of the embodiments of the present disclosure.

In the beginning, such as in step S301, the user manipulates the handwriting device and does writing on the bistable display panel. A sensing unit generates touch signals. The handwriting data includes handwriting positions, and includes pressure values of the handwriting in step S303. In step S305, the handwriting track and the corresponding pressures applied to the display panel form the handwriting positions and pressure values, and the handwriting positions and pressure values are transmitted to the computer device in step S307. Next, the steps can be repeated for synchronously transmitting the handwriting data to the computer device. The function button enables the user to clear the current contents displayed on the handwriting device when the work at this stage comes to an end, such as in step S309. However, the related computer sequence running in the computer device may not be interrupted. The process comes back to step 301 for continuously transmitting the handwriting track and recording the audio.

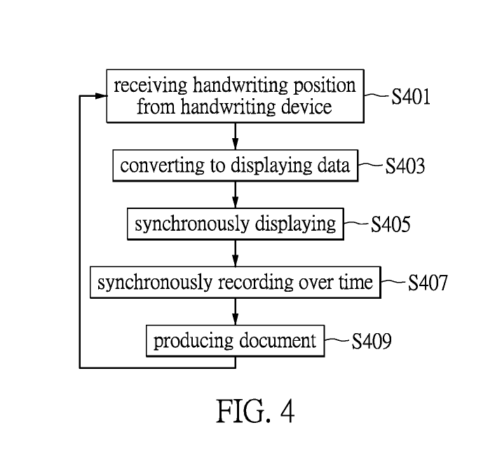

It should be noted that the process for synchronously transmitting and recording the handwriting data continues when the user uses the function buttons until the user actively stops the process. A display of the computer device can faithfully show the changes of the image made by the handwriting over the bistable display panel. FIG. 4 shows a flow chart describing the method running in the computer device for synchronously displaying the handwriting track in one embodiment of the present disclosure.

A software program stored in a non-transitory storage medium of a computer device implements the method. The non-transitory storage medium stores the instructions for performing the method for synchronously displaying the handwriting track. The instructions are executed by one or more processors of the computer device for performing the following processes.

In FIG. 4, such as in step S401, the computer sequence executed in the computer device receives the data of handwriting positions generated by the handwriting device. In step S403, the computer sequence performs a coordinate transformation for transforming the handwriting positions from its original coordinates into the displaying data for the display screen of the computer device. That is because the handwriting may fail to be displayed well by point-to-point transformation as the aspect ratio and resolution of the display screen of the computer device is different from the aspect ratio and resolution of the handwriting device. The handwriting track can be displayed synchronously, such as in step S405. Since the computer sequence executed in the computer device can instantly receive the handwriting data from the handwriting device, the method for synchronously displaying the handwriting track can be achieved. The computer device can receive the handwriting data through a high-frequency polling scheme so that the handwriting track displayed on the display screen of the computer device can be synchronized with the handwriting track displayed on the bistable display panel.

One of the characteristics of the bistable display panel is that the display state of every pixel can be stably maintained until a voltage is given to change its display state. Thus, the computer sequence of the computer device is required to continuously receive the pixel states of the bistable display panel and update the display state only when a voltage is received to change any of the pixel states. In the meantime, the contents of the display screen of the computer device should be updated.

In addition to synchronously displaying the handwriting track in the computer device, such as in step S407, the computer sequence executed in the computer device continuously records the changes of the handwriting track at every moment. The handwriting tracks changed over time can be recorded. A document can be produced by the handwriting track over time, such as in step S409.

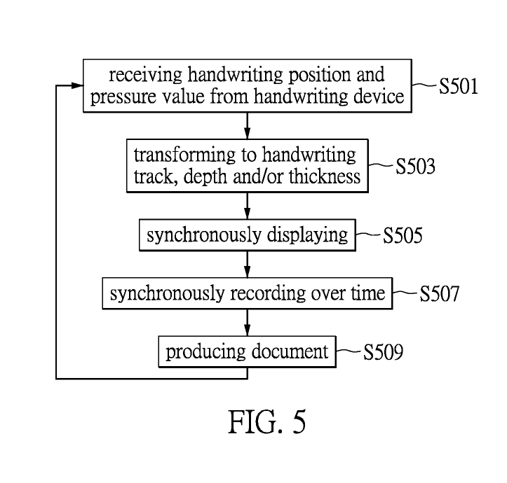

Reference is made to FIG. 5 describing the method for synchronously displaying the handwriting track according to one further embodiment.

In step S501, a sensing circuit of the bistable display panel receives both the handwriting positions and the corresponding pressure values at the same time when a user conducts a handwriting operation. In step S503, the computer sequence executed in the computer device transforms the handwriting positions into a handwriting track, and renders the pressure values to show the depth and/or thickness of the handwriting track. The handwriting positions, the depth and/or thickness of the tracks form the displaying data. In step S505, the computer sequence enables the computer device to show the handwriting data including the tracks and pressure values on the display screen. In step S507, a playable video is created when the handwriting track has been recorded over time.

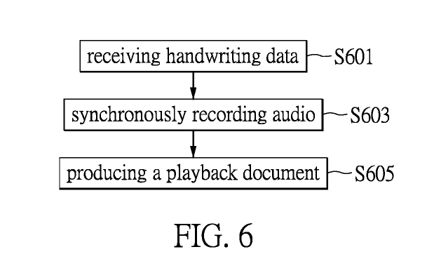

FIG. 6 shows a flow chart describing the method for synchronously displaying the handwriting track in one embodiment of the present disclosure. In the method, in the step of synchronously displaying the handwriting track, a corresponding audio is also synchronously recorded so as to produce a document of the handwriting track over time.

In step S601, while the computer device receives the handwriting data, the computer sequence running in the computer device records the audio simultaneously, such as in step S603. A playback document is therefore produced, such as in step S605. The playback document created in the computer device can be a normal video file, or a video that is playable through a proprietary program.

Thus, the system and method for synchronously displaying the handwriting track, and the handwriting device adopting a bistable display panel are disclosed. The technology of the bistable display panel allows the system to show the handwriting track and synchronously transmit the handwriting data to another computer device. The computer sequence executed in the computer device is in charge of receiving, coordinate transformation, synchronously displaying, and synchronously recording the handwriting track. However, it is noted that the method for synchronously displaying the handwriting track is different from the general handwriting input method or drawing method. By means of the characteristics of the bistable display panel, the system not only can show the handwriting track, but also retain the handwriting process. The bistable display panel is able to present the individual handwriting.

It is intended that the specification and depicted embodiments be considered exemplary only, with a true scope of the invention being determined by the broad meaning of the following claims.

What is claimed is:

1. A system for synchronously displaying a handwriting track, comprising:
a handwriting device, at least including a control unit and a bistable display panel electrically connected to the control unit, a sensing unit and a communication unit, wherein the bistable display panel is used to display a picture that is generated by handwriting; the sensing unit is used to sense handwriting data over the bistable display panel; and the communication unit is used to synchronously transmit the handwriting data to a computer device;
a non-transitory storage medium, in the computer device, used to store a set of instructions that are used to perform a method for synchronously displaying the handwriting track by one or more processors of the computer device comprising:
receiving the handwriting data;
transforming the handwriting data into displaying data; and
synchronously displaying the handwriting track on a display screen of the computer device in response to the displaying data.

2. The system according to claim 1, wherein, in the step of synchronously displaying the handwriting track, an audio is also synchronously recorded so as to produce a document of the handwriting track over time.

3. The system as recited in claim 1, wherein the sensing unit is a touch-sensitive panel, and the handwriting data includes a handwriting position sensed by the touch-sensitive panel over the bistable display panel and a coverage covered by the handwriting position.

4. The system as recited in claim 3, wherein the sensing unit comprises a pressure transducer and the handwriting data further includes a handwriting pressure sensed by the pressure transducer over the bistable display panel for displaying a level of depth or thickness of the handwriting track.

5. The system as recited in claim 4, wherein, in the step of synchronously displaying the handwriting track, an audio is also synchronously recorded so as to produce a document of the handwriting track over time.

6. The system as recited in claim 4, wherein the system supports connecting with multiple handwriting devices, and the method executed by the computer device for synchronously displaying the handwriting track comprises: a connection to one of the handwriting devices being immediately switched on in response to a source of the handwriting data for synchronously displaying the handwriting tracks by integrating the different handwriting devices.

7. The system as recited in claim 6, wherein, in the step of synchronously displaying the handwriting track, an audio is also synchronously recorded so as to produce a document of the handwriting track over time.

8. A method for synchronously displaying a handwriting track, adapted to a system including a handwriting device and a computer sequence executed in a computer device and the handwriting device including a bistable display panel that is used to display a handwriting picture and a sensing unit that is used to sense handwriting data sensed over the bistable display panel, wherein the method comprises:
the computer sequence executed in the computer device receiving the handwriting data from the handwriting device;
transforming the handwriting data into displaying data that is used to be displayed on a display screen of the computer device; and
synchronously displaying the handwriting track on the display screen of the computer device in response to the displaying data.

9. The method as recited in claim 8, wherein, in the step of synchronously displaying the handwriting track, an audio is also synchronously recorded so as to produce a document of the handwriting track over time.

10. The method as recited in claim 8, wherein the handwriting data includes a handwriting position sensed by a touch-sensitive panel over the bistable display panel, and a coverage covered by the handwriting position.

11. The method as recited in claim 10, wherein the sensing unit comprises a pressure transducer and the handwriting data further includes a handwriting pressure sensed by the pressure transducer over the bistable display panel.

12. The method as recited in claim 11, wherein, in the step of synchronously displaying the handwriting track, an audio is also synchronously recorded so as to produce a document of the handwriting track over time.

13. A handwriting device, adapted to the system for synchronously displaying a handwriting track recited in claim 1, and the system connected with a computer device by a wireless or wired communication, wherein the handwriting device comprises:
a control unit used to control operation of the handwriting device;
a bistable display panel, electrically connected to the control unit, used to display a handwriting picture;
a sensing unit, electrically connected to the control unit and the bistable display panel, used to sense handwriting data over the bistable display panel;
a communication unit, electrically connected to the control unit, used to synchronize the handwriting data to the computer device; and
a function interface unit, electrically connected to the control unit, used to provide one or more functions.

14. The device as recited in claim 13, wherein the system supports connecting with multiple handwriting devices, and a connection to one of the handwriting devices is immediately switched on in response to a source of the handwriting data for synchronously displaying the handwriting tracks by integrating the different handwriting devices.

15. The device as recited in claim 13, wherein, when the computer device synchronously displays the handwriting track, an audio is also synchronously recorded so as to produce a document of the handwriting track over time.
